(19) United States
(12) Patent Application Publication
(10) Pub. No.: US 2017/0227507 A1
(43) Pub. Date: Aug. 10, 2017

(54) APPARATUS AND METHOD FOR COUPLING TUBING TO CHROMATOGRAPHIC COLUMN

(71) Applicant: Thermo Finnigan LLC, San Jose, CA (US)

(72) Inventors: John E. BRANN, Shrewsbury, MA (US); Eric A. FRANCE, Quincy, MA (US)

(73) Assignee: Thermo Finnigan LLC

(21) Appl. No.: 15/498,340

(22) Filed: Apr. 26, 2017

Related U.S. Application Data
(62) Division of application No. 13/882,048, filed on May 2, 2013.
(60) Provisional application No. 61/408,039, filed on Oct. 29, 2010.

(51) Int. Cl. G01N 30/60; B01D 15/22; B23P 19/04; F16L 37/20; B01L 3/00; G01N 30/46

(52) U.S. Cl. CPC G01N 30/6004; B01L 3/563; G01N 30/6039; G01N 30/461; B23P 19/04; F16L 37/20; B01D 15/22; B01L 2300/041; G01N 2030/6008

(57) ABSTRACT

A method for coupling a tubing to a liquid chromatography column comprises: passing an end of the tubing through a coupling apparatus comprising: (i) at least one chamber; (ii) a first spring within the at least one chamber configured to transmit a spring force to the tubing; (iii) a second spring within the at least one chamber; and (iv) a deformable sealing member configured to receive a second force from the second spring; inserting the tubing end into a receptacle of an end fitting of the column; and moving the coupling apparatus towards the chromatography column such that the first spring urges the tubing into the receptacle whereby a pressure of the tubing end against the end fitting exceeds a maximum operating fluid pressure of the column and, further, whereby the second spring causes the deformable sealing member to form a fluid seal between the column and the receptacle.

### CROSS-REFERENCE TO RELATED APPLICATIONS

This application is a Divisional application of co-pending U.S. application Ser. No. 13/882,048, which is the United States National Stage Application, under 35 U.S.C. 371, of International Application PCT/US2011/058226 having an international filing date of Oct. 28, 2011, which claims the benefit of the filing date, under 35 U.S.C. 119(e), of U.S. Provisional Application 61/408,039, filed on Oct. 29, 2010, the disclosures of all the aforementioned applications incorporated by reference in their entirety.

### TECHNICAL FIELD

This invention generally relates to liquid chromatography, and more specifically to a mechanism and method for fluidically coupling a chromatographic column to fluid-carrying tubing within a liquid chromatograph system.

### BACKGROUND ART

Liquid chromatography (LC) is well-known in the fields of chemical separation, compound purification and chemical analysis. A central component of a liquid chromatography system is a chromatographic column. The column comprises a capillary tube that is packed with a permeable solid material that either is, itself, a chromatographic stationary phase or otherwise comprises or supports a chromatographic stationary phase. A fluid mixture comprising both a compound of interest for purification or separation as well as a chromatographic mobile phase is caused to flow through the column under pressure from an input end to an output end. Generally, the chemical properties of the stationary phase and the mobile phase are such that the degree of partitioning of the compound of interest between the mobile phase and the stationary phase is different from the degree of partitioning of other compounds within the fluid. As a result, the degree of retention or time of retention of the compound of interest within the column is different from the degree or time of retention of the other compounds, thus causing a physical separation of the compound of interest from the other compounds.

Although chromatograph columns may be re-used for multiple analytical or purification runs, any particular column ultimately needs to be removed from an LC system and replaced with a different one. For instance, physical or chemical degradation of a column packing material or stationary phase or build up of chemical contamination or particulate matter as a result of extended usage may render a column un-usable. As another example, a change in the type of analysis or separation, perhaps corresponding to a different compound of interest, may require replacement of an existing column with a different one whose stationary phase chemistry is better optimized for the new requirements. Especially in high-volume or high-throughput laboratory environments, it may be necessary to frequently connect and disconnect various chromatographic columns. In order to connect or disconnect a column to or from an LC system, it is necessary to make or break fluid couplings between both ends of the column and fluid-carrying tubing lines. Efficiency considerations dictate that such connecting and disconnecting of columns should be as simple and quick as possible and should be able to be performed with minimal system disruption caused by leaking fluid or breakage of components.

Currently, to attach a column to an LC system in a conventional fashion, a user must first properly assemble a compression fitting and ferrule onto the end of a fluid-carrying length of tubing. It is important that the tubing has been cleanly and squarely cut prior to assembly. The assembly must be inserted into a column end fitting while ensuring the assembly (tube, fitting and ferrule) does not fall apart. Then, while pressing the tubing into the column end fitting, the user must tighten the compression fitting into the column end fitting using two properly sized wrenches. The user must be careful not to under tighten the compression screw such that the assembly will be loose and not able to seal. The user must also be careful not to over tighten the compression screw because doing so presents a risk of the assembly galling, the compression screw breaking or the tubing collapsing.

Thereafter, once the first assembly has been properly fitted into the column end fitting, removing the column from the LC system requires the user to again use two wrenches to loosen and disconnect the tubing. Although this procedure may be repeated multiple times with a single assembly, ultimately the wear and material fatigue caused by multiple manual handlings requires replacement of the assembly (the column, tubing or fittings) to mitigate the consequent increased risk of galling, breakage or tube collapse.

Using the current column attachment process, the ferrule is used to both hold the tubing in the column end fitting and create a positive seal. Therefore enough force must be applied to the ferrule to ensure a friction/deformation fit with the tubing to hold the tubing in place. Typically, that force is much greater than necessary to ensure a positive seal between the tube, ferrule and column end fitting, dramatically shortening the number or times a particular assembly can be re-used.

### DISCLOSURE OF INVENTION

The present disclosure teaches a device and method for using it which facilitates the rapid connecting and disconnecting of a chromatograph column to fluid-carrying tubing lines of an LC in such a manner that does not negatively affect chromatography performance and that ensures that resulting connections are capable of sealing at pressures exceeding those found in the LC system. The device is capable of first positioning a tube into the column end fitting such that the tube will be in contact with the column end fitting. Once contact is made the device then applies a spring force (a first force) to the tube which exceeds the opposing force that will be created when the column is at maximum operating pressure. Preferably, the first force should be just great enough to hold the tubing in place at a specified operating pressure. Next, the device ensures that a deformable sealing member (which may be a ferrule) comes in contact with the same column end fitting, encircling the tube. A separate independent spring force (a second force) is applied to the deformable sealing member or ferrule to ensure a proper fluid seal is made between the tube, the sealing member or ferrule and the column end fitting to prevent any leakage at the maximum operating pressure of the column. Preferably, the second force should be just great enough so as to create the proper fluid seal at the specified pressure. The positioning of the tube, sealing member or ferrule, and column end fitting and the spring forces for the tube and sealing member or ferrule are provided by a pushing and latching (or locking) mechanism, for instance a lever contained within the device which provides an appropriate amount of motion and mechanical advantage such that an operator does not require a tool.

In a first aspect of the present teachings, an apparatus for coupling a liquid chromatography column comprising an end fitting to a tubing is disclosed, the apparatus comprising: at least one body member comprising at least one chamber; a first spring within the at least one chamber, the first spring configured so as to apply a first force to the length of tubing towards the column end fitting; a second spring within the second chamber, the second spring configured to apply a second force to a deformable sealing member towards the column end fitting; a moveable support member affixed to the at least one body member; and a pushing and latching or locking mechanism configured to push the at least one body member, first and second springs and moveable support member towards the column end fitting.

In a second aspect of the present teachings, there is disclosed an apparatus for coupling a liquid chromatography column comprising an end fitting to a tubing, the apparatus comprising: a piston comprising at least one chamber; a first spring within the at least one chamber, the first spring configured so as to apply a first force to the length of tubing towards the column end fitting; a second spring within the at least one chamber, the second spring configured to apply a second force to a deformable sealing member towards the column end fitting; a pushing and latching mechanism configured to push the piston, the first spring and the second spring towards the column end fitting; and a housing comprising a supporting structure for the end fitting and having a bore or cavity within which a portion of the piston slidably moves during the pushing of the piston by the pushing and latching mechanism.

In a third aspect of the present teachings, there is disclosed an apparatus for coupling a liquid chromatography column comprising a first end having a first end fitting and a second end having a second end fitting to a first tubing and to a second tubing, the apparatus comprising: a base and a first and a second coupling apparatus affixed to the base, each coupling apparatus for coupling one of the first and second end fittings to one of the first and second tubings, each coupling apparatus comprising at least one body member comprising (a) at least one chamber, (b) a first spring within the at least one chamber, the first spring configured so as to apply a first force to the length of tubing towards the column end fitting; (c) a second spring within the at least one chamber, the second spring configured to apply a second force to a deformable sealing member towards the column end fitting; and (d) a pushing and latching mechanism configured to push the at least one body member, the first spring and the second spring towards the column.

In a fourth aspect of the present teachings, there is disclosed a method for coupling a tubing having a tubing end to a liquid chromatography column comprising the steps of: (a) passing a portion of the tubing, including the tubing end, through a coupling apparatus comprising: (i) at least one chamber; (ii) a first spring within the at least one chamber capable of transmitting a spring force to the tubing; (iii) a second spring within the at least one chamber; and (iv) a deformable sealing member capable of receiving a second force from the second spring; (b) inserting the tubing end into a hollow receptacle of an end fitting of the liquid chromatography column; (c) moving the coupling apparatus towards the chromatography column such that the first spring urges the tubing into the receptacle such that a pressure of the tubing end against the end fitting exceeds a maximum operating fluid pressure of the chromatography column; and (d) further moving the coupling apparatus towards the chromatography column such that the second spring causes the deformable sealing member to form a fluid seal between the column and the receptacle.

### BRIEF DESCRIPTION OF DRAWINGS

The above noted and various other aspects of the present invention will become apparent from the following description which is given by way of example only and with reference to the accompanying drawings, not necessarily drawn to scale, in which:

FIG. 1 is a schematic illustration of a generalized conventional liquid chromatography-mass (LCMS) spectrometry system;

FIG. 2 is a schematic illustration of a liquid chromatography column having conventional couplings to an input tubing and an output tubing;

FIG. 3A is an illustration of an apparatus for coupling a tubing to an end of a chromatographic column in accordance with the present teachings;

FIG. 3B is a perspective view of the column securing mechanism portion of FIG. 3A.

FIG. 4A is an illustration of a portion of a second apparatus for coupling a tubing to an end of a chromatographic column in accordance with the present teachings;

FIG. 4B is an illustration of a portion of a third apparatus for coupling a tubing to an end of a chromatographic column in accordance with the present teachings;

FIG. 5 is an illustration of a system for coupling an input tubing and an output tubing to respective ends of a chromatographic column in accordance with the present teachings;

FIG. 6A is a first perspective view of a fourth apparatus for coupling a tubing to an end of a chromatographic column in accordance with the present teachings;

FIG. 6B is a second perspective view of the apparatus illustrated in FIG. 6A;

FIG. 6C is a cross sectional view taken through the center of and along the main axis of the apparatus illustrated in FIGS. 6A, 6B;

FIG. 6D is a perspective view of a fluid tubing which may be employed in the apparatus of FIGS. 6A, 6B; and

FIG. 7 is a flow diagram of a method for coupling a piece of tubing to a chromatography column in accordance with the present teachings.

### MODES FOR CARRYING OUT THE INVENTION

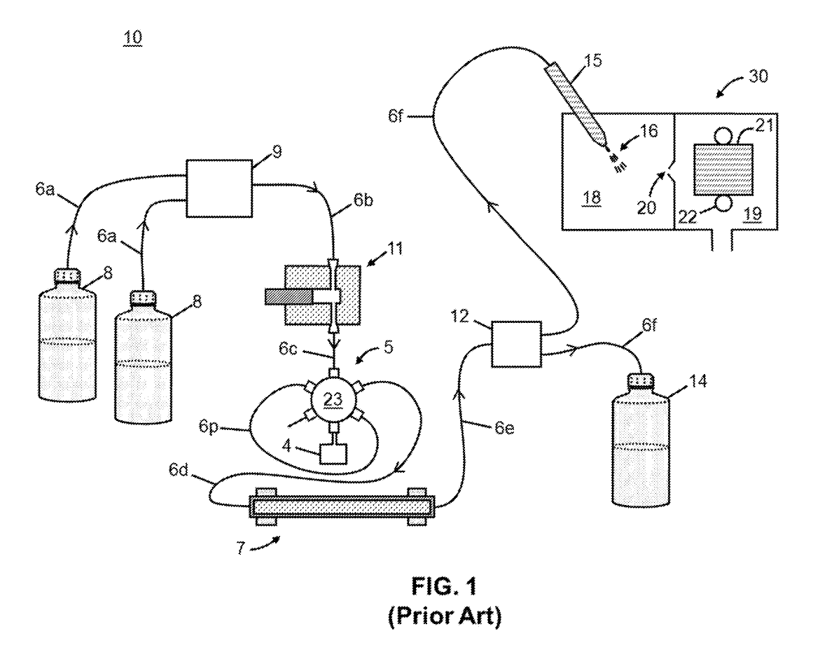

The following description is presented to enable any person skilled in the art to make and use the invention, and is provided in the context of a particular application and its requirements. Various modifications to the described embodiments will be readily apparent to those skilled in the art and the generic principles herein may be applied to other embodiments. Thus, the present invention is not intended to be limited to the embodiments and examples shown but is to be accorded the widest possible scope in accordance with the features and principles shown and described. To fully appreciate the features of the present invention in greater detail, please refer to FIGS. 1-6 in conjunction with the following discussion.

FIG. 1 is a schematic illustration of a conventional liquid chromatography—mass spectrometry (LCMS) system. The system 10 shown in FIG. 1 comprises a chromatograph column 7 for separating a liquid chemical mixture into its constituent substances and a mass spectrometer 30 fluidically coupled to the column 7 for detecting or identifying the separated constituent substances as they are received, in sequence from the column 7. Although a mass spectrometer is illustrated for exemplary purposes, the mass spectrometer portion 30 may be replaced, depending on the needs of a user, by an alternative chemical analytical device for purposes of detecting or identifying the separated constituents. For instance, an infrared transmission or fluorescence detector may be employed for this purpose. Other detection devices are known.

The column 7 shown in FIG. 1 receives a fluid stream comprising one or more selected solvent fluids supplied from solvent containers 8 as well as a sample of interest from sample injector 4. The various different solvent fluids, which may comprise a chromatographic mobile phase, are delivered along fluid tubing lines 6a to valve 9 which may mix the fluids or select a particular fluid. As illustrated, the valve 9 is a three-way valve but may comprise a more complex valve or valve system if more than two different solvent fluids are provided. The fluids are drawn into the system 10 and propelled to the chromatographic column 7 therein by means of a pump 11 that is fluidically coupled to the output of the valve 9 by fluid tubing line 6b. The solvent fluids output from the pump along fluid tubing line 6c are mixed together with a sample provided by sample injector 4 by a mixing apparatus 5, which may comprise, in a well-known fashion, a multiple-port rotary valve 23 and an injection loop 6p fluidically coupled between two of the ports.

Still referring to FIG. 1, it may be observed that an input of the column 7 is fluidically coupled to and receives a mixture of sample and solvent fluids from an output port of the mixing apparatus 5 by fluid tubing line 6d. Differential partitioning of the various chemical constituents of the mixture between the mobile phase and a stationary phase packed within the column leads to differential retention of the various constituents within the column and consequent different respective times of elution of the constituents from the column output to fluid tubing line 6e. An optional split valve 12 may separate the eluting substances, along fluid tubing lines 6f, into a split portion that is delivered to waste or storage container 14 and an analysis portion that is delivered the mass spectrometer 30. The mass spectrometer may comprise various well-known components, such as an atmospheric pressure ionization source 15 that delivers a stream of charged particles 16 including ionized constituents into an ionization chamber 18. The resulting charged particles are received, through an aperture 20, into one or more evacuated chambers 19, at least one of which contains a mass analyzer 21 for separating ions according to their respective mass-to-charge ratios and one or more detectors 22 for detecting the separated ions.

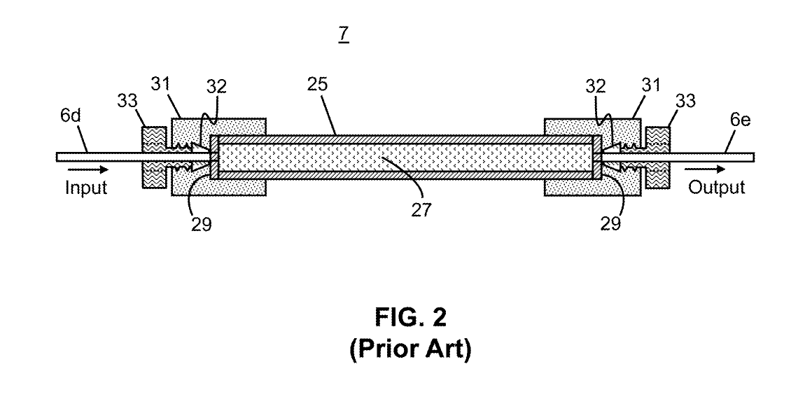

FIG. 2 is a schematic illustration of a conventional liquid chromatography column and its associated couplings to fluid tubing lines. The column 7 receives a fluid mixture at an input end from fluid tubing line 6d, separates the mixture into its constituents and outputs the separated constituents, at respective elution times, from an output end to fluid tubing line 6e. The column comprises a hollow capillary tube 25, the interior of which is packed with a porous material 27, such as a size-sorted granular material, which comprises the stationary phase. End caps 29 on either end of the capillary tube 25 serve to retain the porous material within the capillary tube 25 and to maintain an operating pressure within the tube. The column is provided with end fittings 31 at either end, each of which forms a portion of a compression fitting for sealing a fluid tubing line (6d, 6e) against an end cap. In some implementations or designs, the column end cap may not comprise a separate component but may, instead, be integral with the end fitting or else the end fitting may provide the functions of an end cap. In this document, the term “end fitting” is used in a broad sense so as to include separate end caps, fittings with integral end caps or separate end fittings and end caps used pair-wise in conjunction with one another. The compression seal is completed, at each end of the column, by a ferrule 32 which may be tightly compressed into a bore of the associated fitting 31 by a threaded nut or screw 33 so as to deform in a fashion that creates a leak-tight seal between the ferrule, fluid tubing line and end fitting.

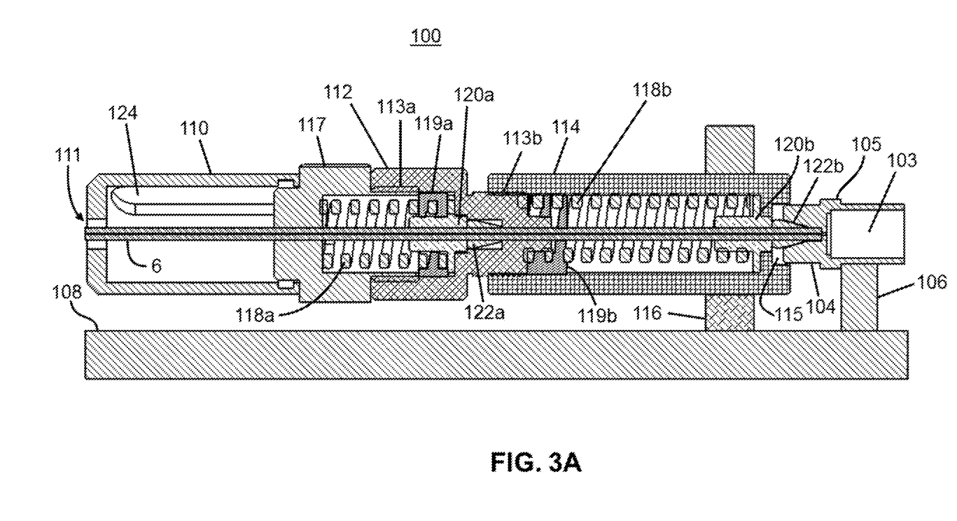

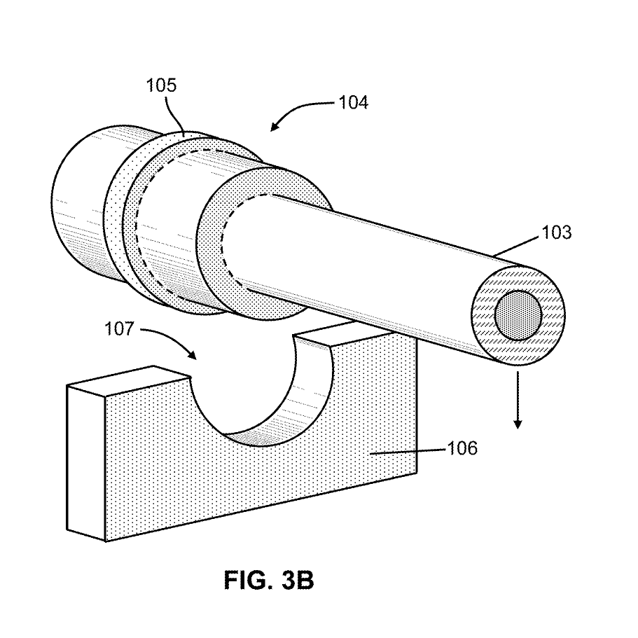

FIG. 3A is an illustration of an apparatus 100 for coupling a tubing to an end of a chromatographic column in accordance with the present teachings. In operation, a tubing 6 passes completely through the apparatus 100 substantially parallel to an axis of the apparatus through various apertures 111 of the apparatus. The apparatus 100 is operable so as to apply a force to the tubing 6 so that the tubing is pressed into the end fitting 104 so as to form a fluid coupling with the column 103. The apparatus 100 is further operable so as to apply a second force to a sealing member 122b (which may be a ferrule) so as to deform the sealing member in a fashion that creates a leak-tight seal between the tubing 6, end fitting 104 and column 103. Both such forces are applied substantially parallel to the common axis of the apparatus 100 and the column 103, thereby preventing application of any twisting motions or forces to the column.

The coupling apparatus 100 shown in FIG. 3A comprises a hollow distal (or outer) body member 110, a hollow intermediate body member 112 and a hollow proximal (or inner) body member 114 where the terms “distal” and “proximal” refer to spatial relationships taken with respect to a chromatograph column 103 having a column end fitting 104. The distal body member 110 is attached to the intermediate body member 112 by a first threaded coupling 113a and the intermediate body member 112 is attached to the proximal body member 114 by a second threaded coupling 113b. The assembled body members are supported, as a group, on a base or housing 108 by a support member 116 which is either affixed to or rigidly clamped onto the proximal body member 114. The column 103 is supported by a column support member 106 which fits at least partially around the column end fitting 104 as shown in FIG. 3B.

The support member 116 of the apparatus 100 (FIG. 3A) is engaged to the base or housing 108 so as to be moveable, in substantially one direction only, with respect to the housing. Such slidable engagement may be implemented, for instance, by the use of a rail (not shown). Such a rail could be rigidly attached to the support member and designed so as to slide within a matching groove (not shown) in the base or housing. One of ordinary skill in the mechanical arts could readily devise other slidable engagement configurations and couplings.

In contrast to the slidable nature of the coupling between the support member 116 and the base or housing 108, the column support member 106 is rigidly fixed in place with respect to the base or housing 108. As shown in FIG. 3B, the column support member 106 comprises a salient or re-entrant portion 107 which is designed to mate with and partially enclose a portion of the column end fitting 104. Either the column end fitting or the column support may be constructed of a slightly pliable material such that the end fitting 104, together with the column 103, “snaps” into a defined and reproducible position within the salient 107 when the column is moved, under force, in the direction of the downward pointing arrow of FIG. 3B. A stopping mechanism of the column end fitting 104, such as circumferential ridge 105, prevents movement of the end fitting and column when force is applied to the free end of the column by the apparatus 100 during the operation of coupling a tubing 6 to the column. Although the stopping mechanism is illustrated as a circumferential ridge 105 in FIG. 3B, it could alternatively be implemented as a different form of protrusion, such as a boss, knob or pin. The combination of the slidable coupling between the support member 116 and the base or housing 108 and the fixed coupling between the column support member 106 and the base or housing permits the apparatus 100 (comprising the assembly of three body members 110, 112, 114 and associated components further discussed following) to be moved towards or retracted from the column 103 and its associated column fitting 104 by movement parallel to an axis of the apparatus 100. Optionally, the slidable coupling may be provided with a latching or locking mechanism to prevent movement when a desired position is achieved.

Returning now to the discussion of FIG. 3A, it may readily be observed that the apparatus 100 further comprises two springs assembled within the apparatus so as to provide separate spring forces parallel to an axis of the apparatus. A first spring 118a is disposed within a first chamber of the apparatus defined between the intermediate body member 112 and an end cap 117 of the distal body member 110. A second spring 118b is disposed within a second chamber of the apparatus defined between the intermediate body member 112 and the proximal body member 114. The first spring 118a is held against a first bushing or washer 120a by a first spring retainer 119a. Likewise, the second spring 118b is held against a second bushing or washer 120b by a second spring retainer 119b. During assembly, the first spring 118a is pre-loaded with a first pre-determined compressive force, by progressive engagement of the first threaded coupling 113a, so as to compress the first spring between the end cap 117 and the first bushing or washer 120a. Note that the first bushing or washer 120a is held in place against an interior wall of the intermediate body member 112 during this operation. Likewise, during assembly, the second spring 118b is pre-loaded with a second pre-determined compressive force, greater than the first pre-determined compressive force, by progressive engagement of the second threaded coupling 113b, so as to compress the second spring between the intermediate body member 112 and the second bushing or washer 120b. Note that the second bushing or washer 120b is held in place against an interior wall of the proximal body member 114 during this operation.

Prior to assembly of the distal body member 110 onto the intermediate body member 112, a ferrule 122a is placed into a hollow interior portion of the intermediate body member. The purpose of the ferrule 122a is to transfer force provided by the first spring 118a through the bushing or washer 120a to a tubing 6 such that the tubing is pressed into the column end fitting 104 with sufficient force so that the pressure between the tubing and the end fitting exceeds the fluid pressure—typically 15000 psi for HPLC systems—achieved in the column under normal operating conditions. Since the body of the tubing is generally constructed of metal, the ferrule 122a is preferably constructed of a metal—for instance, stainless steel—having a hardness that is equivalent to or greater than that of the tubing. With such choice of material, force applied to the ferrule 122a in the direction of the column 103 will tend to cause the ferrule 122a to wedge itself into the tubing wall so as create a tight metal-to-metal friction seal. In alternative embodiments, the ferrule 122a may be replaced by a shape on or integral with the tubing 6, such as a ridge, groove, ring, etc. In operation, the formed shape portion of the tubing may engage with a clamp, ring, washer, bushing etc. in contact with the first spring 118a in order to transfer spring force to the tubing 6.

In operation, the apparatus 100 also comprises a deformable sealing member 122b, which may be a second ferrule, which is placed on the tubing 6 just prior to positioning the tubing end into the column end fitting 104. The purpose of the deformable sealing member 122b is to deform, under application of force provided by the second spring 118b through the bushing or washer 120b so as to form a leak-tight seal between the tubing, end fitting and column. Accordingly, the deformable sealing member 122b is preferably constructed of an elastic polymer material such as polyether ether ketone (PEEK).

When the apparatus 100 is not in operation providing coupling between a tubing and a column, the pre-loaded spring forces are respectively taken up between the end cap 117 of the distal body member 110 and the intermediate body member 112 and between the intermediate body member and the proximal body member 114. A user may place the apparatus 100 in operation (with the tubing 6 and the ferrule 122a already in place within the apparatus and the deformable sealing member 122b already in place on the tubing) by operating a mechanism 124 (comprising both a pushing mechanism and a locking or latching mechanism) which pushes the three body members (and, consequently, also the support member 116, the tubing 6 and the hardware within the body members) in the direction of the fixed column 103 and its end fitting 104.

Once the tubing comes into contact with the end fitting, further application of force (by continued operation of the pushing and latching mechanism) causes the tubing to apply an increasing force against the first spring 118a through the ferrule 122a and the first bushing or washer 120a. Once the opposing force provided by the tubing exceeds the pre-loaded spring force on spring 118a, continued operation of the pushing and latching mechanism will cause the spring to compress, thereby enabling movement of the apparatus such the deformable sealing member 122b comes into contact with both the proximal body member 114 and the column end fitting 104. Further operation of the pushing and latching mechanism causes both compression of the first spring 118a as well as application of an increasing opposing against the second spring 118b through the deformable sealing member 122b and the second bushing or washer 120b. Still further operation of the pushing and latching mechanism causes both springs 118a, 118b to compress with consequent increase in spring force applied to the tubing and to the deformable sealing member. The increasing force and pressure on the deformable sealing member 122b causes this component to deform within the column end fitting 104 and around the tubing so as to create a leak-tight pressure seal.

A recess 115 in the end of the proximal body member 114 may be provided so as to provide a gap for accommodation of the deformable sealing member 122b and to guide the relative movement between the coupling apparatus 100 and the column end fitting 104 during the pushing and latching procedure. The pre-compression of the springs prior to actual operation of the apparatus ensures that minimal actual movement of parts is required to achieve the required or appropriate final forces on the tubing and on the deformable sealing member or second ferrule.

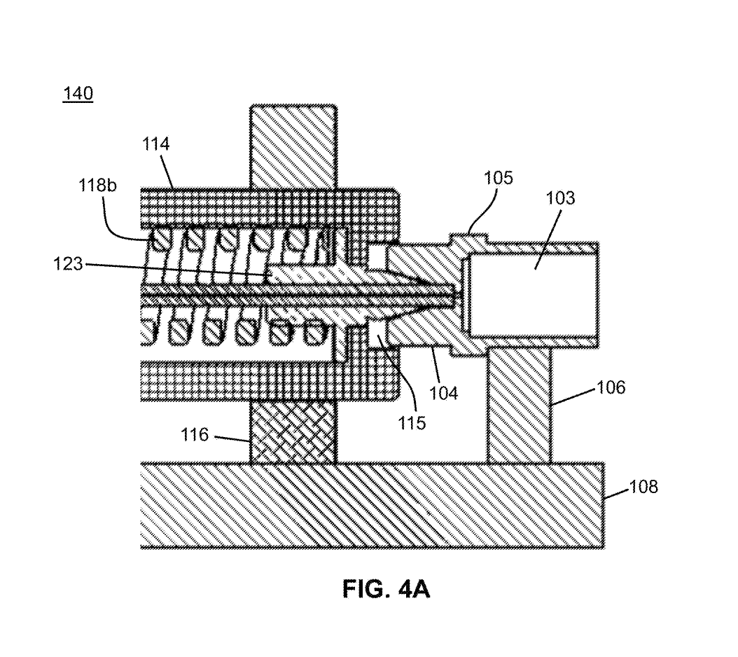

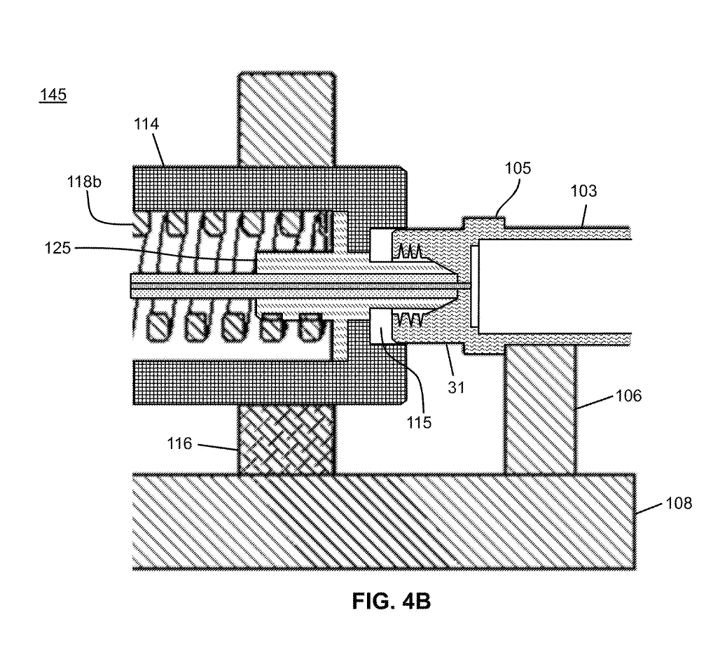

FIGS. 4A-4B are illustrations of end portions of two alternative apparatuses for coupling a tubing to an end of a chromatographic column in accordance with the present teachings. The apparatuses 140, 145 shown in FIGS. 4A, 4B are similar, in most respects, to the apparatus 100 illustrated in FIG. 3A. However the apparatuses 140, 145 differ from the apparatus 100 in regards to the manner in which the tubing 6 is sealed to an end fitting 104, 31 and to the column 103. Whereas, in the apparatus 100, the deformable sealing member 122b may simply comprise a second ferrule, in the apparatus 140 shown in FIG. 4A, a single integral, single-bodied sealing member 123 replaces both the second bushing or washer 120b and the sealing member 122b. The sealing member 123 comprises a deformable material so as to create a leak-tight seal between the tubing 6, the end fitting 104 and the column 103 under force from the second spring 118b.

In the apparatus 145 shown in FIG. 4B, another integral, single-bodied sealing member 125 is employed for such sealing purposes. The sealing member 125 of the alternative apparatus 145 (FIG. 4B) is a modified version of the sealing member shown in FIG. 4A in which a portion extending outward from the proximal body member 114 is elongated, such that the tubing 6 can be sealingly coupled to a conventional column end fitting 31 using the novel coupling apparatus 145. Recall from FIG. 2 that a portion of many conventional end fittings, such as the conventional end-fitting 31, has a bore with an internal screw thread. This internal screw thread is designed to mate with external threads of a threaded nut or screw 33 that may be rotated so as to provide a compression force. Although such screw threads are not employed in the illustrated novel embodiments disclosed herein, it is nonetheless desirable to be able to employ the invention in conjunction with existing chromatographic columns having conventional fittings. Accordingly, the sealing member 125 has an elongated portion that has a diameter smaller than the internal diameter of the threaded portion of the end fitting 31. In this way, the sealing member 125 is adapted so as to extend into the conventional column end fitting without contacting the threads, thereby bypassing the threaded portion. Inward of the threads, the deformable sealing member 125 engages, in operation, with a tapered portion of the bore of the conventional end-fitting, thereby forming a leak-tight seal in a manner similar to the way in which the deformable sealing member or second ferrule 122b creates a seal against the un-threaded end fitting 104 (FIG. 3A). Upon disconnection of a tubing from a chromatographic column using either apparatus 140 or apparatus 145, the sealing member (either sealing member 123 or sealing member 125) may remain either attached to or within the proximal body member 114, thereby eliminating the requirement for a user to supply or insert a ferrule at the next use of the respective apparatus.

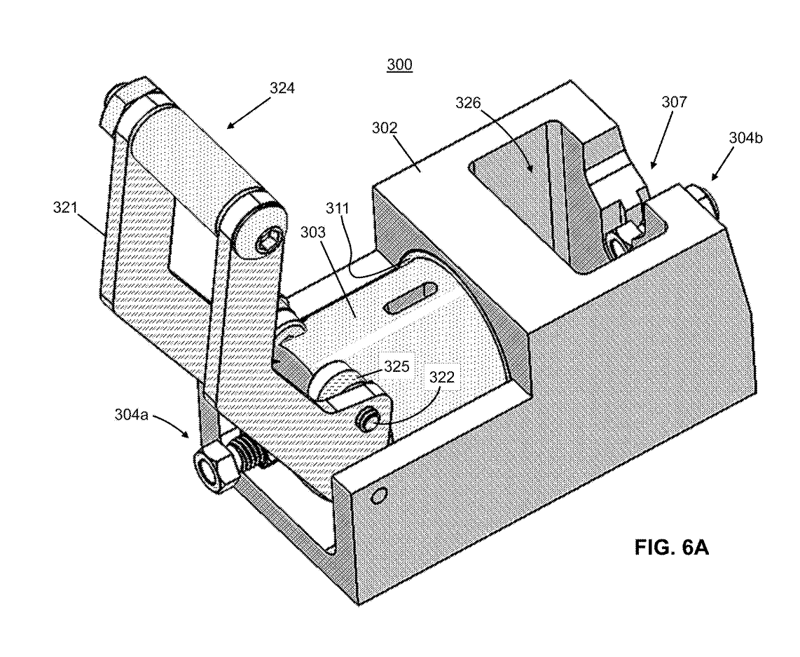

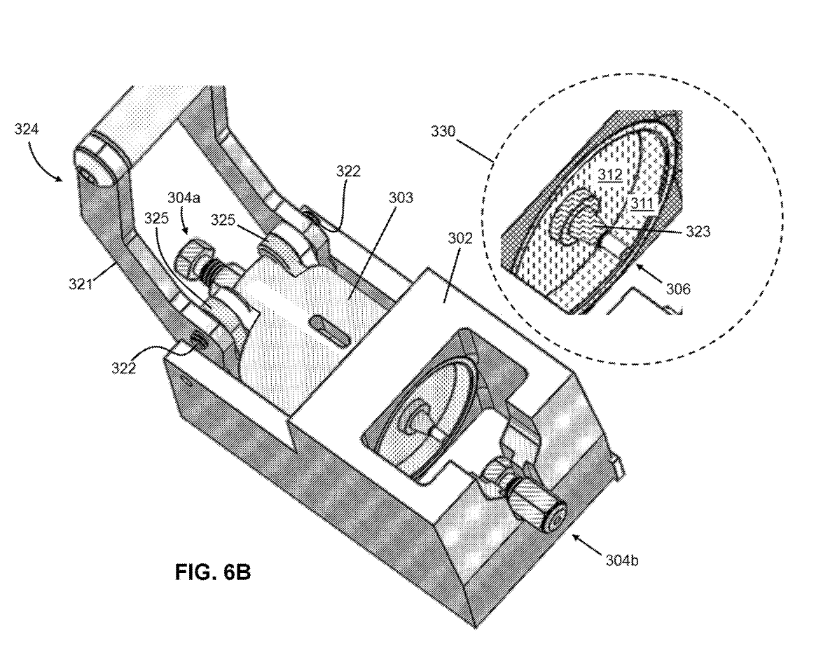

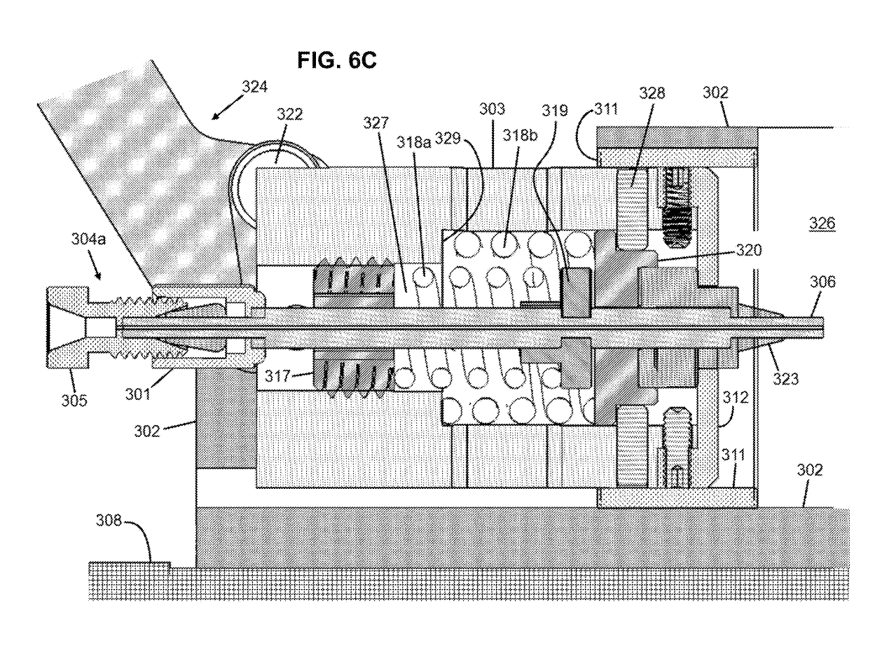

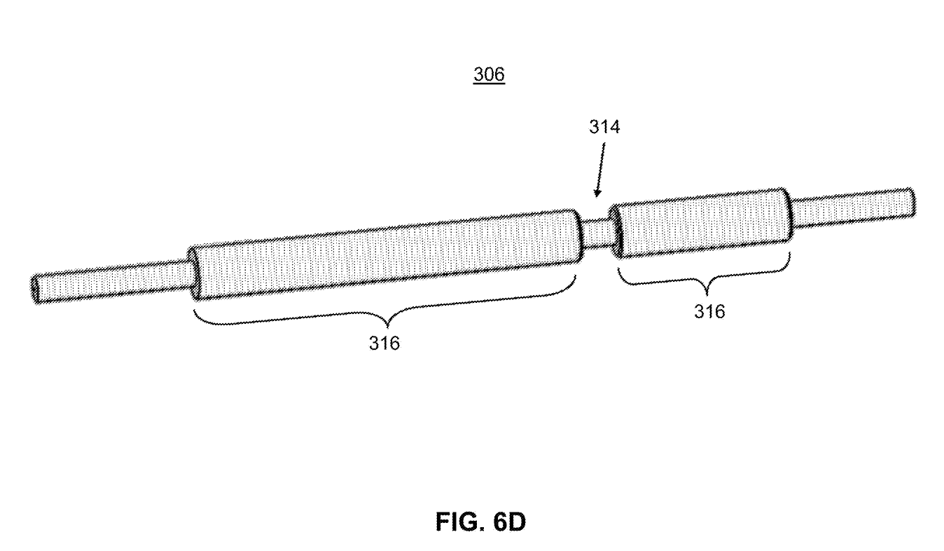

The coupling apparatuses described above each employ two springs which are deployed in a non-overlapping end-to-end spatial relationship as considered along the main axis of the respective apparatus. However, space along the axial dimension may be saved, if desired, by providing a modified coupling apparatus design in which the springs at least partially overlap along the axial dimension as, for example, when one spring resides at least partially within a space enclosed by the other spring. An example of one such coupling apparatus is shown in FIGS. 6A-6C.

Referring in detail now to the coupling apparatus 300, FIGS. 6A and 6B are first and second perspective external views of the fully assembled apparatus 300. Considered generally, the apparatus 300 comprises a housing 302 that is a first body member of the apparatus and a piston 303 that is a second body member of the apparatus. The housing 302 has an open bore or cavity 326. The piston 303 is capable of being slidably inserted at least partially into the bore or cavity 326 of the housing and is also capable of being at least partially retracted from the bore or cavity. Preferably, a portion of bore or cavity 326 comprises a shape that mates with the portion of the piston which is capable of being slidably inserted into the bore or cavity. If this portion of the piston is cylindrical, then the piston and bore may be said to comprise a piston-cylinder relationship.

A bushing or other bearing 311 may be provided within the portion of the bore or cavity 326 that receives the portion of the piston 303 so as to provide a smooth sliding surface for insertion and retraction of the piston. The movement of the piston into or partial retraction of the piston from the housing may be controlled manually by a user by means of a pushing and latching (or locking) mechanism 324. As shown the pushing and latching mechanism may comprise a hand operated lever 321 and a coupling bar 325 such that the coupling bar 325 is mechanically engaged to the lever 321 by means of a first pivot pin 322 about which an end of the coupling bar is free to rotate. A second pivot pin (not shown) similarly provides mechanical engagement between the opposite end of the coupling bar 325 and the piston 303 so that rotational motion of the lever 321 is converted into translational motion of the piston.

The piston 303 has a chamber 327 therein through which a length of tubing 306 passes. The inset drawing 330 of FIG. 3B shows a portion of the apparatus 300 in magnified view so that an end portion of the tubing 306 may be seen protruding beyond an end plate 312 of the piston 303. A sealing member 323, which is a part of the apparatus and which may be a deformable ferrule, encloses a portion of the tubing 306 such that the end portion of the tubing protudes partially beyond the sealing member 323. The sealing member 323 has a conical outer surface which is designed to mate with a conical inner surface of a conventional end fitting 304b (which is not necessarily a component of the apparatus 300 but which is shown for clarity) so as to provide a leak-tight seal within the end fitting 304b. In operation, the end-fitting 304b will generally be mounted on an end of a chromatograph column (not shown) which will be either an inlet end or an outlet end of the column. Accordingly, with the tubing 306 and sealing member 323 inserted into the end fitting 304b by means of the coupling apparatus 300, the tubing 306 will either deliver fluid into or receive fluid from the chromatograph column.

In the views shown in FIGS. 6A, 6B, the coupling apparatus is shown in an open position, such that the end of the tubing 306 is retracted from the end fitting 304b. In this open configuration, the chromatograph column may be removed or replaced. The same or a different chromatograph column may then be positioned in the correct placement so as to receive the end of the tubing 306 by positioning its end fitting into a slot, recess or groove 307 (FIG. 6A) of the housing 302. Thus, a portion of the housing comprising the slot, recess or groove 307 provides the same functionality as the column support member 106 discussed previously herein in conjunction with other embodiments. Subsequently, the pushing and latching mechanism 324 is operated so as to cause the piston 303 to move further into the bore or cavity 326 with the tubing 306 being carried along with such motion until the tubing end engages with the end fitting 304b. Further operation of the lever in the same direction causes a leak-tight seal to be formed between the tubing and the end fitting in a manner described below.

FIG. 6C is a cross-sectional view through the center of the piston 303 of the apparatus 300 and also through the center of the tubing 306 that illustrates internal components within the chamber 327 of the piston. FIG. 6C also illustrates that the housing 302 may be affixed to a base plate or external housing 308, so as to provide positional stabilization of the apparatus 300 as previously discussed in regard to other embodiments. The components within the chamber 327 enable the apparatus 300 to provide a leak-tight seal between the tubing 306 and the chromatograph column end fitting 304b, even under high pressures encountered in HPLC applications, without the need for a user to employ a tool or to apply any twisting motion or torque to either the tubing or the column.

As may be observed from FIG. 6C, the piston chamber 327 has disposed within it a first helically coiled spring 318a and a second helically coiled spring 318b that has an internal diameter that is greater than the external diameter of the first spring. The springs are disposed such that they are at least partially overlapping—that is, such that at least a portion of the first spring 318a resides within a volume or space defined by the internal diameter of the second spring 318b. The tubing 306 passes substantially parallel to and along the common axis of the two springs 318a, 318b. In operation, the first helically coiled spring 318a (FIG. 6C) transmits a first spring force to the tubing 306 by means of a collar, sleeve or flange 319 that abuts an end of the first spring. The collar, sleeve or flange 319 is either affixed to or tightly engaged with the tubing 306 so as to apply a force to the tubing in a direction substantially parallel to its axis and towards the end fitting 304b. A screw 317 which is threaded into a portion of the piston chamber 327 abuts the other end of the first spring and may be pre-adjusted so as to provide a desired pre-loaded compressional force to the spring. The second helically coiled spring 318b transmits a second spring force to the sealing member 323 by means of an intermediate push plate 320, such as a bushing or a flange. The second spring 318b is restrained within the piston chamber 327 by push plate 320 at the end nearest to the end fitting 304b and by an internal wall 329 of the chamber at the other end. The push plate 320 is restrained within the chamber 327, against the spring forces, by a mechanical stop or stops 328 which are engaged to a piston wall or walls and which may comprise, for example, a set of pins passing through holes in the piston wall, a locking ring or flange secured by an internal groove in an interior piston wall or any other boss or knob engaged to or affixed to the piston. The mechanical stop or stops prevent the springs from pushing themselves and/or other components out of the chamber 327 when the pushing and latching mechanism is in the open position such that the tubing 306 is retracted from the end fitting 304b.

FIG. 6D is a perspective view of the isolated tubing 306. In this exemplary embodiment, the tubing 306 is a specially designed tubing which is designed so as to engage with the collar, sleeve or flange 319 so as to be thus mechanically coupled to the first helically coiled spring 318a. As shown, the tubing comprises one or more enlarged-outer-diameter portions 316 between which is defined a groove 314 which, in operation, engages with a portion of the collar, sleeve or flange 319. The end portions of the tubing 306 preferably comprise a standard outer diameter so as to be operable conventional end fittings or tubing connection fittings. One of ordinary skill in the art will appreciate that, alternatively, the groove 314 may be eliminated in favor of a flange or ring affixed to a tubing of standard diameter throughout. In this alternative case, the affixed flange or ring is the component 319.

In routine operation of this exemplary apparatus embodiment, the tubing 306 will remain with the apparatus 300 throughout the course of several engagement and disengagement operations of the apparatus wherein such operations are associated with, for example, several removal and replacement operations of one or more chromatograph columns. At the end of the tubing opposite to the cartridge, the tubing 306 may be connected to a length of conventional chromatography tubing (not shown) by means of a conventional tubing connection fitting 304a comprising a coupling nut 301, a tubular coupling body 305 and a ferrule 309. The circumstances under which the conventional tubing (or the tubing 306) must be replaced will ordinarily be less frequent than the situations under which a column is removed, added or replaced. At those times when the conventional tubing or tubing 306 must be replaced, the connection and disconnection of the tubing lengths may be accomplished, in standard fashion, by disconnecting the tubing connection fitting 304a. Under no circumstances, however, is there any requirement to use an installation tool or to apply a twisting motion or a torque to the chromatograph column or its end fitting using the disclosed apparatus.

In operation of the coupling apparatus 300, after the protruding end of the tubing 306 makes contact with the end fitting 304b, further movement of the hand lever 321 in the same direction does not cause further movement of the tubing with respect to the end fitting 304b or the housing because of the positionally fixed nature of the tubing with respect to the housing. Instead, continued movement of the hand lever and piston causes additional compression of the first spring 318a such that spring force from the first spring is applied to the tubing 306 in a direction towards the end fitting. Because of the pre-loaded compression previously applied to the first spring, the pressure between the tubing and the end fitting increases rapidly from zero to some final pressure concurrent with movement of the hand lever 321 into its final latched position. The final pressure between the tubing and the end fitting is such as to exceed the fluid pressure—typically 15000 psi for HPLC systems—achieved in the column under normal operating conditions. At the same time, or possibly commencing slightly after the tubing 306 makes contact with the end fitting 304b, movement of the piston internal wall 329 against the second spring 318b causes increasing spring force to be applied to the sealing member 323 through the push plate 320, so as to deform, under application of force provided by the second spring 318b, so as to form a leak-tight seal between the tubing, end fitting and column. Accordingly, the deformable sealing member 323 is preferably constructed of an elastic polymer material such as polyether ether ketone (PEEK).

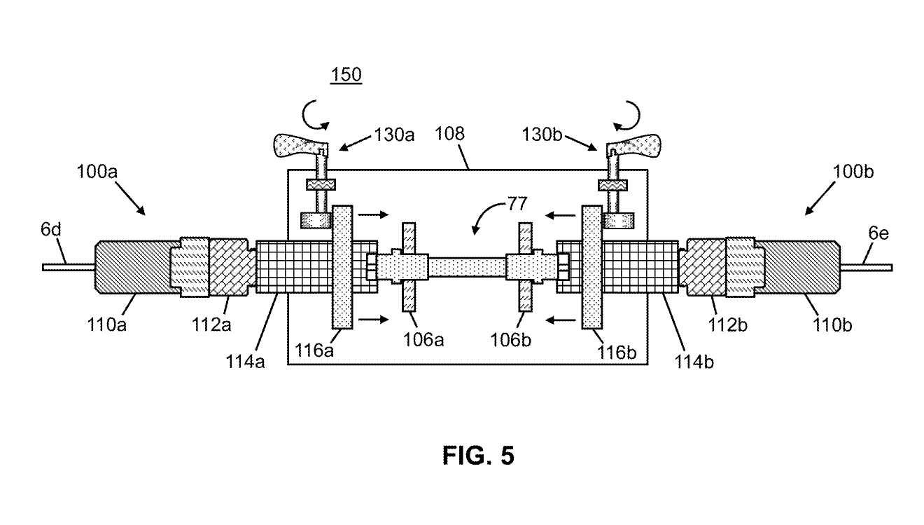

Frequently, it is desirable or required to perform coupling operations at both ends of a chromatograph column. For instance, when a column is replaced, couplings at both ends of the replaced column must be disconnected and couplings formed at both ends of the replacement column. Accordingly, FIG. 5 illustrates a system for coupling an input tubing and an output tubing to respective ends of a chromatographic column in accordance with the present teachings. The specific system 150 shown in FIG. 5 may be utilized with any of the coupling apparatuses 100 (FIG. 3A), 140 (FIG. 4A) or 145 (FIG. 4B) or with similar coupling apparatuses. The system 150 comprises a single base or housing 108 that supports both a first coupling apparatus 100a and a second coupling apparatus 100b at opposite ends of a chromatograph column 77 by means of a first slidable support member 116a and a second slidable support member 116b, respectively. The column is supported in a fixed position relative to the base or housing 108 by column support members 106a and 106b at the input end and output end, respectively, of the column 77. The slidable support members (116a, 116b), column supports (106a, 106b) and coupling apparatuses (100a, 100b) are similar to the analogous components previously described with respect to FIGS. 3A-3B. Thus, the coupling apparatus 100a, which comprises distal body member 110a, intermediate body member 112a and proximal body member 114a, serves to couple an input tubing 6d to the input end of the column 77. Likewise, the coupling apparatus 100b, which comprises distal body member 110b, intermediate body member 112b and proximal body member 114b, serves to couple an output tubing 6e to the output end of the column 77. A first pushing and latching or locking mechanism 130a and a second pushing and latching or locking mechanism 130b are each operable by a user so as to provide the compressional motions described previously.

It is straightforward and easy to construct a system that provides the functionality shown in FIG. 5 using two coupling apparatuses 300 as shown in FIGS. 6A-6C or using similar apparatuses. Because each coupling apparatus 300 provides a built-in support structure for a column end fitting as well as a slidable piston, the slidable support members (116a, 116b) and column supports (106a, 106b) shown in FIG. 5 are rendered un-necessary. All that is required is to attach two instances of the apparatus 300 facing one another on a base plate or on or within an external housing 308 (see FIG. 6C) at an appropriate distance from one another such that the two end fittings of a chromatography column fit easily into the slots recesses or grooves of the two coupling apparatuses. To accommodate columns of different lengths, it may be desirable to attach at least one of the coupling apparatuses to the base plate or housing in a slidable or otherwise adjustable fashion such that the distance between the two coupling apparatuses may be adjusted.

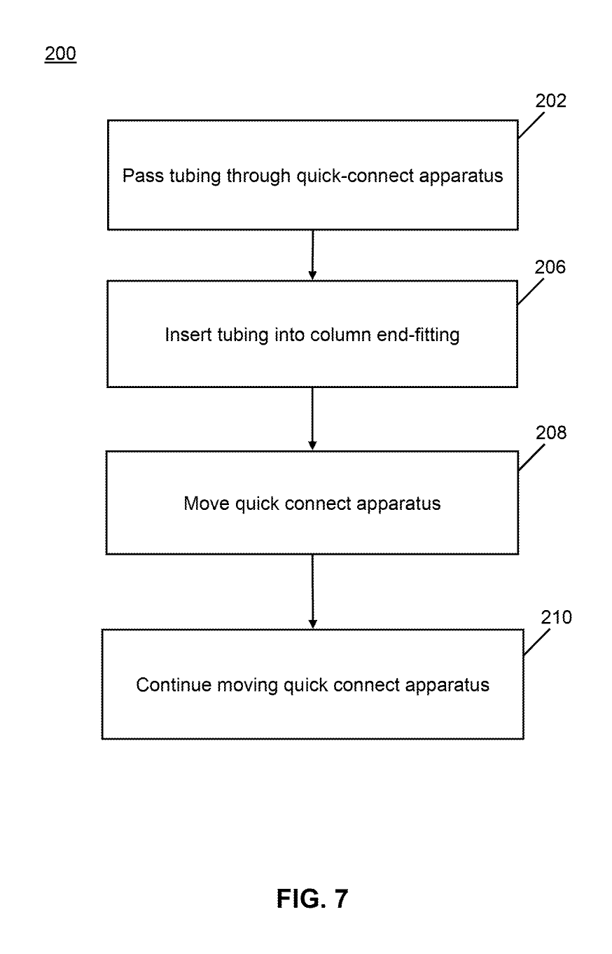

FIG. 7 is a flow diagram of a method, method 200, for coupling tubing to a chromatography column in accordance with the present teachings. The method 200 is especially pertinent for use in conjunction with any of the coupling apparatuses 100 (FIG. 3A), 140 (FIG. 4A) or 145 (FIG. 4B) or with similar coupling apparatuses. The first step, Step 202, of the method 200 comprises passing a portion of a piece of chromatography tubing, including a tubing end, through a coupling apparatus comprising: a deformable sealing member and at least one chamber having a first spring and a second spring wherein the first spring is capable of transmitting a spring force from the first spring to the chromatography tubing and wherein the deformable sealing member is capable of receiving a force from the second spring. The act of passing the portion of the piece of chromatography tubing through the apparatus may be eliminated if the tubing and apparatus have already been used in a previous connection procedure. In such a case, this step becomes a step of merely providing the described apparatus with the tubing passing through it.

In the next step, Step 206, the tubing end is inserted into a hollow receptacle of the chromatography column end fitting. Then, in Step 208, the coupling apparatus is moved towards the chromatography column such that the first urges the tubing into the receptacle with a force that creates a pressure of the tubing end against the end fitting that exceeds the fluid pressure that will be created when the column is at its maximum operating pressure. In Step 210, the movement of the quick connect apparatus towards the chromatographic column is continued such that the second spring causes the deformable sealing member to form a fluid seal between the column and the receptacle so as to prevent any leakage at the maximum operating pressure.

After a column has been connected to chromatography tubing as described and utilized in the coupled configuration, the disconnect operation is trivial—the user simply operates the pushing and latching mechanism in the opposite direction from the direction used to connect the column and tubing. The disconnect operation may be as simple as simply pushing a lever in a reverse direction so as to release the applied forces and disengage the apparatus and tubing from the column end fitting. One of ordinary skill in the mechanical arts will readily understand how to provide a pushing and latching mechanism that performs this reverse operation.

Improved apparatus and methods for coupling tubing to a chromatographic column have been disclosed. Using the disclosed apparatus, a user may simply place a column and a portion of tubing including a tubing end into the device and operate a pushing mechanism, such as a lever. As previously described, the positioning of the tube and column end fitting, as well as the application of the appropriate forces is assured by the device. As the holding force on the tube is separate from the sealing force on the sealing member, which may be a ferrule, each force can be set only as necessary, enabling reuse of the tube and ferrule many times more as compared to typical combination of tube and ferrule. The apparatus eliminates the need for twisting motions applied to either the column or tubing, provides highly reproducible connecting and disconnecting operations and provides an appropriate amount of motion and mechanical advantage such that an operator does not require a tool, either for connecting a column to or disconnecting a column from tubing.

The discussion included in this application is intended to serve as a basic description. Although the present invention has been described in accordance with the various embodiments shown and described, one of ordinary skill in the art will readily recognize that there could be variations to the embodiments and those variations would be within the spirit and scope of the present invention. The reader should be aware that the specific discussion may not explicitly describe all embodiments possible; many alternatives are implicit. Accordingly, many modifications may be made by one of ordinary skill in the art without departing from the scope of the claimed invention. Neither the description nor the terminology is intended to limit the scope of the invention. All patent application disclosures, patent application publications or other publications are hereby explicitly incorporated by reference herein as if fully set forth herein.

What is claimed is:

1. A method for coupling a tubing having a tubing end to a liquid chromatography column comprising the steps of:
(a) passing a portion of the tubing, including the tubing end, through a coupling apparatus comprising:
(i) at least one chamber;
(ii) a first spring within the at least one chamber configured to transmit a spring force to the tubing through a first ferrule;
(iii) a second spring within the at least one chamber; and
(iv) a deformable sealing member configured to receive a second force from the second spring;
(b) inserting the tubing end into a hollow receptacle of an end fitting of the liquid chromatography column;
(c) moving the coupling apparatus towards the chromatography column such that the first spring applies force to the tubing that urges the tubing end into the receptacle such that a pressure of the tubing end against the end fitting exceeds a maximum operating fluid pressure of the chromatography column; and
(d) further moving the coupling apparatus towards the chromatography column such that the second spring causes the deformable sealing member to form a fluid seal between the column and the receptacle.

2. A method as recited in claim 1, wherein the moving and the further moving of the coupling apparatus towards the chromatography column does not apply twisting motion or torque to the chromatography column.

3. A method as recited in claim 1, wherein the moving and the further moving of the coupling apparatus towards the chromatography column comprises moving the coupling axis parallel to an axis of the coupling apparatus.

4. A method as recited in claim 3, wherein the moving and the further moving of the coupling apparatus towards the chromatography column comprises moving, relative to a base or housing, the coupling apparatus and a moveable support member to which the coupling apparatus is attached, wherein the support member comprises a sliding engagement with the base or housing and wherein the chromatography column is rigidly fixed in place relative to the base or housing.

5. A method as recited in claim 3, wherein:
the passing of the portion of the tubing through the first spring comprises passing the portion of the tubing through a first spring that provides a first spring force that is parallel to the axis of the coupling apparatus; and
the passing of the portion of the tubing through the second spring comprises passing the portion of the tubing through a second spring that provides a second spring force that is parallel to the axis of the coupling apparatus.

6. A method as recited in claim 2, wherein the passing of the tubing end through the first spring and the second spring comprises passing the tubing end through the first spring within a first chamber of the at least one chamber and, subsequently, passing the tubing end through the second end within a second chamber of the at least one chamber.

7. A method as recited in claim 2, wherein the passing of the tubing end through the first spring and the second spring comprises passing the tubing end through the first and second springs within a single chamber, wherein at least a portion of the first spring is disposed within the second spring.

8. A method as recited in claim 2, wherein:
the inserting of the tubing end into the hollow receptacle of the end fitting of the liquid chromatography column comprises inserting the tubing end into a hollow receptacle having an internal screw thread along a portion thereof; and
the formation of the fluid seal between the column and the receptacle is provided by a deformable sealing member that has a portion having an outer diameter that is smaller than an inner diameter of the threaded portion of the hollow receptacle.

9. A method as recited in claim 2, further comprising, after the step of passing the portion of the tubing through the second spring within the at least one chamber:
passing the portion of the tubing out of the at least one chamber; and
placing the deformable sealing member onto the portion of the tubing, wherein the deformable sealing member comprises a second ferrule.

10. A method as recited in claim 2, further comprising, prior to the step (a) of passing the portion of the tubing, including the tubing end, through the coupling apparatus, the steps of:
pre-loading the first spring with a first pre-determined compressive force; and
pre-loading the second spring with a second pre-determined compressive force, wherein the second pre-determined compressive force is greater than the first pre-determined compressive force.

11. A method for coupling a fluid tubing line of a liquid chromatography system to a liquid chromatography column comprising the steps of:
(a) providing a coupling apparatus comprising:
(i) a housing comprising:
a column support portion; and
a bore;
(ii) a piston comprising a chamber, the chamber including therein:
an internal tube having a first end, a second end and a collar, sleeve or flange affixed thereto;
a deformable sealing member surrounding a portion of the internal tube adjacent the second end of the internal tube;
a pusher plate surrounding another portion of the internal tube and in contact with the deformable sealing member;
a first spring mounted between and bearing upon the a wall of the chamber and the collar sleeve or flange; and
a second spring mounted between and bearing upon the pusher plate and a wall of the chamber; and
(iii) a pushing and latching mechanism;
(b) positioning an end of the liquid chromatography column having an end fitting on or within the support portion;
(c) fluidically coupling the fluid tubing line to the inlet end of the internal tube; and
(d) applying force to the pushing and latching mechanism to cause the piston to slide within the bore such that the outlet end of the tube moves towards and contacts the end fitting of the liquid chromatography column and such that the deformable sealing member forms a leak-tight seal between the second and of the internal tube and the end fitting.

12. A method as recited in claim 11, wherein the providing (a) of the coupling apparatus includes the steps of:
pre-loading the first spring with a first pre-determined compressive force; and
pre-loading the second spring with a second pre-determined compressive force, wherein the second pre-determined compressive force is greater than or equal to the first pre-determined compressive force.

13. A method as recited in claim 12, wherein the step (c) of fluidically coupling the fluid tubing line to the inlet end of the internal tube comprises employing a conventional tubing connection fitting attached to the first end of the internal tube, the conventional tubing connection fitting comprising: a threaded coupling nut, a tubular coupling body, and a ferrule.
